(19) United States
(12) Patent Application Publication
(10) Pub. No.: US 2025/0112892 A1
(43) Pub. Date: Apr. 3, 2025

(54) Process-Aware Identity Firewall

(71) Applicant: VMware LLC, Palo Alto, CA (US)

(72) Inventors: MANISHA SAMEER GAMBHIR PAREKH, Pune (IN); KEDAR BHALCHANDRA CHAUDHARI, Pune (IN)

(21) Appl. No.: 18/607,364

(22) Filed: Mar. 15, 2024

(30) Foreign Application Priority Data
Oct. 2, 2023 (IN) 202341066036

(51) Int. Cl. H04L 9/40

(52) U.S. Cl. CPC H04L 63/0236; H04L 63/0263

(57) ABSTRACT

Example methods and systems for implementing an process-aware identity firewall are described. In one example, a computer system may detect a request for a virtualized computing instance to access a resource. The computer system may obtain (a) identity information identifying a user or a user device associated with the virtualized computing instance and (b) process information associated with a process that initiates the request to access the resource. The computer system may map the identity information, the network event information and the process information to an identity firewall rule that includes at least (a) a first parameter that is mappable to the identity information, (b) a second parameter that is mappable to the network event information and (c) a third parameter that is mappable to the process information. The identity firewall rule may be applied to allow or block the request to access the resource.

### CROSS-REFERENCES

This application claims the benefit of Indian Patent Application number 202341066036, entitled “PROCESS-AWARE IDENTITY FIREWALL,” filed on Oct. 2, 2023, of which is hereby incorporated by reference in its entirety.

### BACKGROUND

Virtualization allows the abstraction and pooling of hardware resources to support virtual machines in a software-defined networking (SDN) environment, such as a software-defined data center (SDDC). For example, through server virtualization, virtual machines running different operating systems may be supported by the same physical machine (also referred to as a “host”). Each virtual machine is generally provisioned with virtual resources to run an operating system and applications. The virtual resources may include central processing unit (CPU) resources, memory resources, storage resources, etc. In order to meet requirements of granularity and scalability in the SDN environment, a firewall engine may be deployed on each host to protect VMs against security threats. For example, after a user logs onto a particular VM to access various resources in the SDN environment, the firewall engine may be configured to filter traffic to and from the VM.

### BRIEF DESCRIPTION OF THE DRAWINGS

FIG. 1 is a schematic diagram illustrating an example software-defined networking (SDN) environment in which a process-aware identity firewall may be implemented;

FIG. 2 is a schematic diagram illustrating an example process-aware identity firewall in an SDN environment;

FIG. 3 is a flowchart of an example process for a computer system to implement a process-aware identity firewall in an SDN environment;

FIG. 4 is a flowchart of an example detailed process for process-aware identity firewall in an SDN environment;

FIG. 5 is a schematic diagram illustrating a detailed example of process-aware identity firewall according to the example in FIG. 4; and

FIG. 6 is a schematic diagram illustrating example process-aware identity firewall rules.

### DETAILED DESCRIPTION

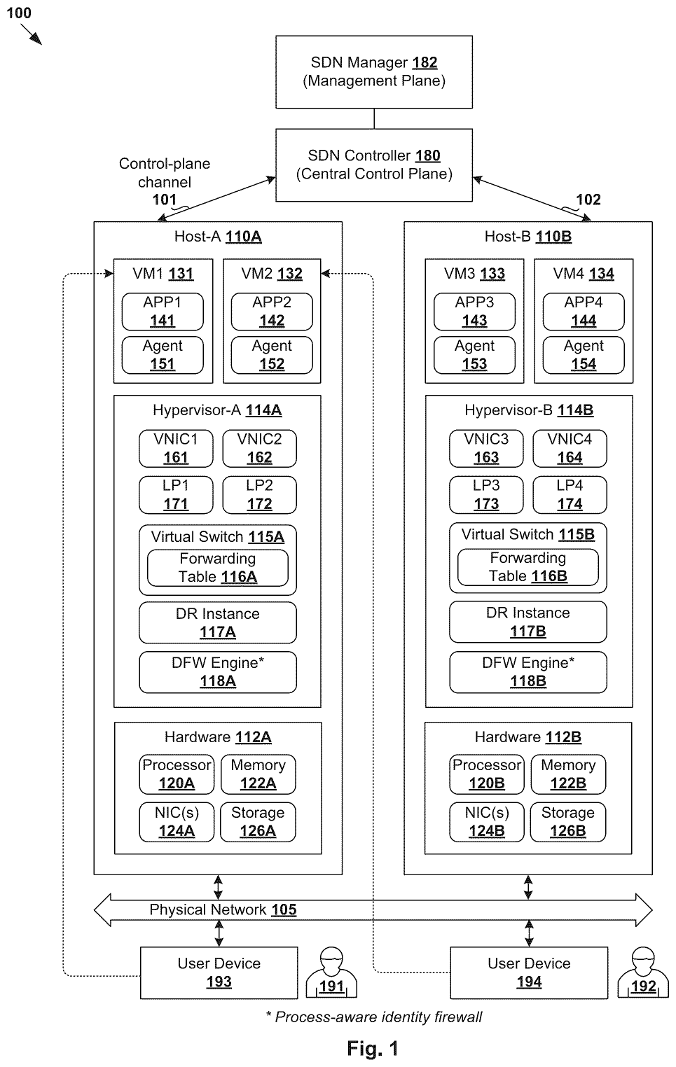

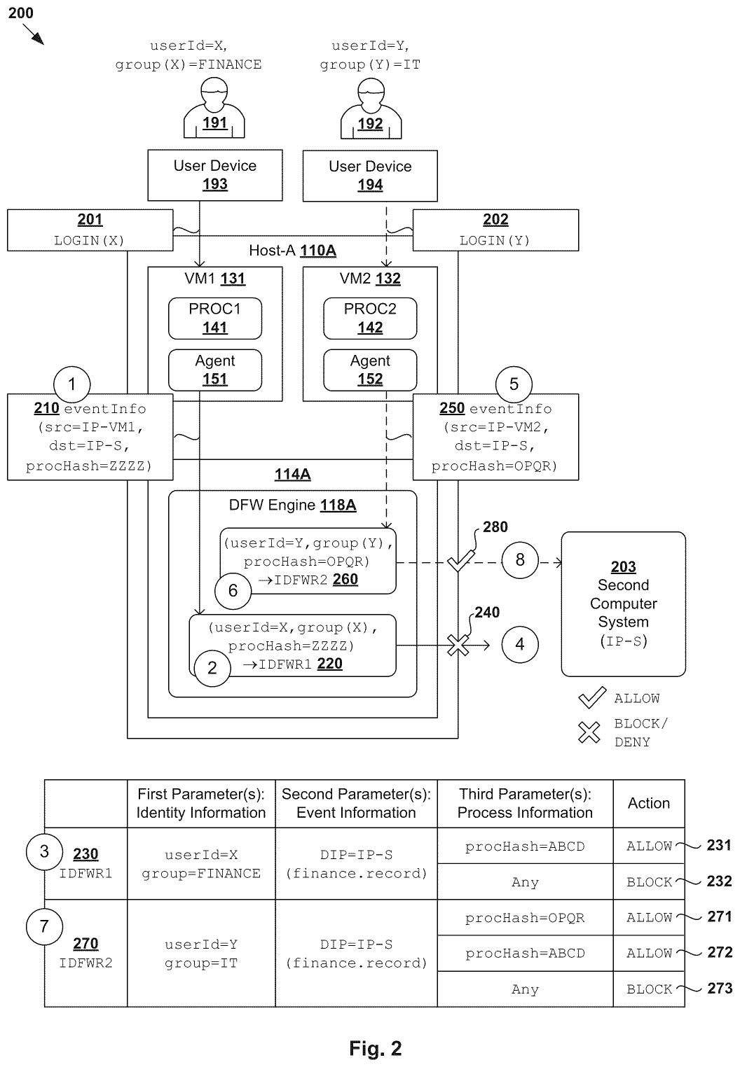

According to examples of the present disclosure, process-aware identity firewall may be implemented to enhance data center security. As used herein, the term “process-aware identity firewall” may refer generally to a type of identity firewall that is capable of controlling access to resources based at least on identity information associated with a user or user device, as well as process information associated with a process that requests access to a resource. One example may involve a first computer system (e.g., host-A 110A in FIGS. 1-2) detecting a request for a virtualized computing instance to access a resource from a second computer system (e.g., server 203 in FIG. 2) based on network event information (e.g., 210 in FIG. 2). The first computer system may obtain (a) identity information identifying a user or a user device associated with the virtualized computing instance and (b) process information associated with a process that initiates the request to access the resource (e.g., 220 in FIG. 2).

Next, the first computer system may map the identity information, the network event information and the process information to an identity firewall rule (e.g., 230 in FIG. 2). The identity firewall rule may include at least (a) a first parameter that is mappable to the identity information, (b) a second parameter that is mappable to the network event information and (c) a third parameter that is mappable to the process information. The identity firewall rule may be applied to allow or block the request to access the resource, thereby controlling access to the resource based on the identity information, the network event information, and the process information (e.g., 240 in FIG. 2). Examples of the present disclosure may be implemented to provide, inter alia, process-based fencing of network connections on virtualized computing instances to reduce the risk of security attacks in a data center.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Throughout the present disclosure, it should be understood that although the terms “first” and “second” are used to describe various elements, these elements should not be limited by these terms. These terms are used to distinguish one element from another. A first element may be referred to as a second element, and vice versa.

FIG. 1 is a schematic diagram illustrating example software-defined networking (SDN) environment 100 in which process-aware identity firewall may be implemented. It should be understood that, depending on the desired implementation, SDN environment 100 may include additional and/or alternative components than that shown in FIG. 1. SDN environment 100 includes multiple hosts 110A-B that are inter-connected via physical network 105. In practice, SDN environment 100 may include any number of hosts (also known as a “host computers”, “host devices”, “physical servers”, “server systems”, “transport nodes,” etc.), where each host may be supporting tens or hundreds of virtual machines (VMs).

Each host 110A/110B may include suitable hardware 112A/112B and virtualization software (e.g., hypervisor-A 114A, hypervisor-B 114B) to support various VMs. For example, hosts 110A-B may support respective VMs 131-134. Hypervisor 114A/114B maintains a mapping between underlying hardware 112A/112B and virtual resources allocated to respective VMs. Hardware 112A/112B includes suitable physical components, such as central processing unit(s) (CPU(s)) or processor(s) 120A/120B; memory 122A/122B; physical network interface controllers (NICs) 124A/124B; and storage disk(s) 126A/126B, etc.

Virtual resources are allocated to respective VMs 131-134 to support a guest operating system (OS; not shown for simplicity) and application(s) or process(es) 141-144. For example, the virtual resources may include virtual CPU, guest physical memory, virtual disk, virtual network interface controller (VNIC), etc. Hardware resources may be emulated using virtual machine monitors (VMMs). For example in FIG. 1, VNICs 161-164 are virtual network adapters for VMs 131-134, respectively, and are emulated by corresponding VMMs (not shown for simplicity) instantiated by their respective hypervisor at respective host-A 110A and host-B 110B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 114A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 114A/114B implements virtual switch 115A/115B and logical distributed router (DR) instance 117A/117B to handle egress packets from, and ingress packets to, corresponding VMs. In SDN environment 100, logical switches and logical DRs may be implemented in a distributed manner and can span multiple hosts. For example, logical switches that provide logical layer-2 connectivity, i.e., an overlay network, may be implemented collectively by virtual switches 115A-B and represented internally using forwarding tables 116A-B at respective virtual switches 115A-B. Forwarding tables 116A-B may each include entries that collectively implement the respective logical switches. Further, logical DRs that provide logical layer-3 connectivity may be implemented collectively by DR instances 117A-B and represented internally using routing tables (not shown) at respective DR instances 117A-B. The routing tables may each include entries that collectively implement the respective logical DRs.

Packets may be received from, or sent to, each VM via an associated logical port. For example, logical switch ports 171-174 are associated with respective VMs 131-134. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 115A-B in FIG. 1, whereas a “virtual switch” may refer generally to a software switch or software implementation of a physical switch. In practice, there is usually a one-to-one mapping between a logical port on a logical switch and a virtual port on virtual switch 115A/115B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

Through virtualization of networking services in SDN environment 100, logical networks (also referred to as overlay networks or logical overlay networks) may be provisioned, changed, stored, deleted and restored programmatically without having to reconfigure the underlying physical hardware architecture. A logical network may be formed using any suitable tunneling protocol, such as Virtual extensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks. In the example in FIG. 1, VM1 131 on host-A 110A and VM3 133 on host-B 110B may be connected to the same logical switch and located on the same logical layer-2 segment, such as a segment with VXLAN network identifier (VNI)=6000.

SDN controller 180 and SDN manager 182 are example network management entities in SDN environment 100. One example of an SDN controller is the NSX controller component of VMware NSX® (available from VMware, Inc.) that operates on a central control plane. SDN controller 180 may be a member of a controller cluster (not shown for simplicity) that is configurable using SDN manager 182 operating on a management plane. Network management entity 180/182 may be implemented using physical machine(s), VM(s), or both. Logical switches, logical routers, and logical overlay networks may be configured using SDN controller 180, SDN manager 182, etc. To send or receive control information, a local control plane (LCP) agent (not shown) on host 110A/110B may interact with SDN controller 180 via control-plane channel 101/102.

Hosts 110A-B may also maintain data-plane connectivity with each other via physical network 105 to facilitate communication among VMs located on the same logical overlay network. Hypervisor 114A/114B may implement a virtual tunnel endpoint (VTEP) (not shown) to encapsulate and decapsulate packets with an outer header (also known as a tunnel header) identifying the relevant logical overlay network (e.g., using a VXLAN (or “virtual” network identifier (VNI) added to a header field). For example in FIG. 1, hypervisor-A 114A implements a first VTEP associated with (IP address=IP-A, MAC address=MAC-A, VTEP label=VTEP-A), and hypervisor-B 114B a second VTEP with (IP-B, MAC-B, VTEP-B), etc. Encapsulated packets may be sent via an end-to-end, bi-directional communication path (known as a tunnel) between a pair of VTEPs over physical network 105.

One of the challenges in SDN environment 100 is improving the overall data center security, such as preventing or reducing the likelihood of malicious connections being established within corporate networks. To protect VMs 131-134 against security threats, hypervisor 114A/114B implements distributed firewall (DFW) engine 119A/119B to filter packets to and from associated VMs. For example, at host-A 110A, hypervisor 114A implements DFW engine 118A to filter packets for VM1 131 and VM2 132. SDN controller 160 may be used to configure firewall rules that are enforceable by distributed firewall engine 119A/119B. In practice, network packets may be filtered according to firewall rules at any point along the datapath from a source (e.g., VM1 131) to a physical NIC (e.g., 124A). In one embodiment, a filter component (not shown) may be incorporated into each VNIC 141-144 to enforce firewall rules that are associated with the VM (e.g., VM1 131) corresponding to that VNIC (e.g., VNIC 161). The filter components may be maintained by DFW engines 118A-B.

Conventionally, firewall rules are generally defined using five tuples to match a specific packet flow, such as source IP address, source port number (PN), destination IP address, destination PN, and protocol, in addition to an action (e.g., allow or block). To achieve better security in SDN environment 100, DFW engine 119A/119B may implement an identity firewall (also referred to as IDFW) based on firewall rules that are applicable to a specific user (e.g., based on Active Directory information) or group of users, rather than just five tuples. This helps reduces, if not prevents, unauthorized access to resources, as it is generally more difficult for attackers to spoof identities.

In practice, some attackers may still be able to get through firewalls. For example, the attackers may rely on fileless malware, which is a type of malicious software that does not require any files to be written to the disk in order to execute. In some cases, fileless malware may be undetectable by anti-virus solutions. Once fileless malware infects a system (e.g., VM1 131), it may use a variety of techniques to execute, such as exploiting vulnerabilities in legitimate applications, using scripting languages (e.g., Powershell), etc. The fileless malware may perform a variety of malicious activities, including accessing sensitive information (e.g., financial records, patient records) maintained by an organization, etc. Such attacks are undesirable.

### Process-Aware Identity Firewall

According to examples of the present disclosure, process-aware identity firewalls may be implemented to improve data center security. For example, the process-aware identity firewall may be configured to correlate (a) identity information associated with user(s) or user device(s), (b) network event information based on which requests for resource access are detectable and (c) process information associated with process(es) requesting the resource access. By correlating information associated with various users, processes and networks, as well as applying security policies based on the correlated information, examples of the present disclosure may provide more granular access control for network resources in SDN environment 100.

Examples of the present disclosure may be implemented to provide process-based fencing of network connections related to resource access. Using examples of the present disclosure, host 110A/110B may determine whether an authorized user is using an authorized process to perform an authorized network activity (e.g., establishing a network connection). As used herein, the term “process” may refer generally to an instance of a computer program that is being executed on a computer system (e.g., virtualized computing instance). Example processes may include OS processes, web browsers, word processors, email clients, media players, background services, etc. Depending on the desired implementation, a process may be referred to as, or associated with, any of the following: task, job, program, application, service, thread, daemon, instance, session, activity, workload, operation, routine, etc.

In more detail, FIG. 2 is a schematic diagram illustrating example process-aware identity firewall 200 in SDN environment 100. In this example, first user 191 (user ID=X) may log onto VM1 131, and second user 192 (user ID=Y) into VM2 132 using respective user devices 193-194 (see 201-202). First user 191 is a member of group=FINANCE, and second user 192 a member of group=IT. Any suitable process-aware identity firewall rule(s) may be configured for each group (see 230-232 and 270-273). To facilitate the enforcement of firewall rules by DFW engines 118A-B, identity information associated with user 191/192 may be gathered when user 191/192 logs in. During the login process, authentication is performed to verify the identity of user 191/192 based on any suitable credentials, such as username or login name, user ID, password, biometric information, etc. In practice, virtual desktop infrastructure (VDI) may be implemented to allow user 191/192 to host a desktop OS on VM 131/132 (i.e., VM-based desktop). In general, VDI is a technology developed to provide virtual rather than physical desktops to users, who may connect to the virtual desktops from different locations using different user devices.

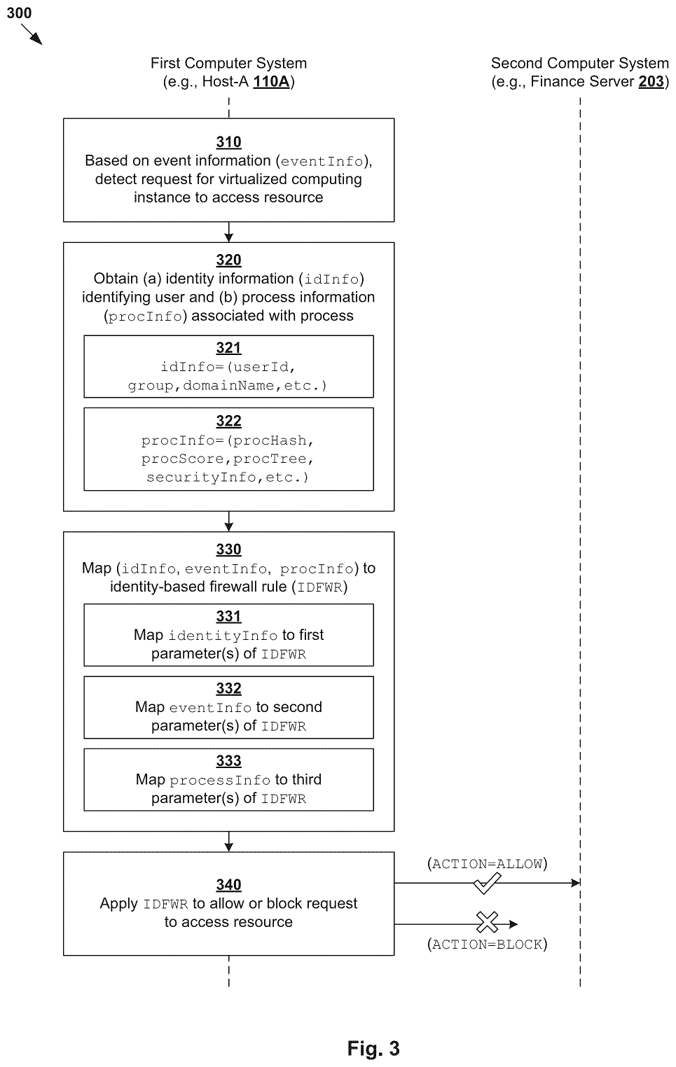

The example in FIG. 2 will be explained using FIG. 3 is a flowchart of example process 300 for a computer system to perform process-aware identity firewall in SDN environment 100. Example process 300 may include one or more operations, functions, or actions illustrated by one or more blocks, such as 310 to 340. The various blocks may be combined into fewer blocks, divided into additional blocks, and/or eliminated depending on the desired implementation. Examples of the present disclosure may be implemented using any suitable “first computer system” (e.g., host 110A/110B) and “second computer system” (e.g., destination finance server 203), etc. Host 110A/110B may implement examples of the present disclosure using DFW engine 118A/118B (i.e., process-aware identity firewall engine) and/or guest introspection agent 151/152 running on guest OS on VM 131/132, etc.

At 210 in FIGS. 2 and 310 in FIG. 3, host-A 110A may detect a first request for VM1 131 to access resource(s) based on network event information. For example, the first request may be in the form of a connection establishment request to access sensitive information (e.g., financial records) from finance server 203. Depending on the desired implementation, network event information 210 (denoted as eventInfo) may be obtained from guest introspection agent 151 that is capable of detecting various events on VM1 131. Network event information 210 may include source IP address=IP-VM1 associated with VM1 131, destination IP address=IP-S associated with finance server 203, etc.

At 220 in FIGS. 2 and 320 in FIG. 3, host-A 110A may obtain (a) identity information identifying first user 191 and/or first user device 193 logged onto VM1 131 and (b) process information associated with process 141 (denoted as PROC1) that initiates the first request to access the resource. The term “obtain” or “obtaining” may refer generally to retrieving or receiving the information from any suitable source(s). For example, the identity information (denoted as identityInfo) may include a user identifier (ID) denoted as userld=X associated with first user 191, group=FINANCE assigned to first user 191, domain name=ABC associated with first user 191, etc. The process information (denoted as processInfo) associated with PROC1 141 may include a process hash, a process score, process tree information, security information (e.g., cryptographic protocols, certificate information), etc. See 321-322 in FIG. 3.

At 230 in FIGS. 2 and 330 in FIG. 3, host-A 110A may map the (identityInfo, eventInfo, processInfo) to identity-based firewall rule=IDFWR1. For example, IDFWR1 230 may include first parameter(s) mappable to identity information that includes (user ID=X, group=FINANCE) associated with first user 191. IDFWR1 230 may also include second parameter(s) mappable to network event information that includes destination=finance server 203 (e.g., IP address=IP-S). Further, IDFWR1 230 may include third parameter(s) mappable to process information, such as process hash=“ZZZZ” associated with PROC1 141, etc. See 331-333 in FIG. 3.

At 240 in FIGS. 2 and 340 in FIG. 3, host-A 110A may apply matching identity firewall rule to allow or block the first request to access the resource, thereby controlling access to the resource based on the identity information, the network event information, and the process information. In the example in FIG. 2, host-A 110A may apply IDFWR1 230 to perform action=BLOCK the first request based on process hash=“ZZZZ” (see 232) associated with unauthorized PROC1 141. Here, IDFWR1 230 may be configured to allow first user 191 with (user ID=X, group=FINANCE) to use an authorized/approved process with process hash=“ABCD” to access resource(s) from finance server 203 (see 231).

Similarly, blocks 310-340 in FIG. 3 may be performed to allow VM2 132 to access resource(s) from finance server 203. In this case, at 250 in FIG. 2, host-A 110A may detect a second request for VM2 132 to access the resource(s) based on network event information. At 260, host-A 110A may obtain (a) identity information associated second user 192 and/or second user device 194 and (b) process information associated with PROC2 142 that initiates the request. At 270-280, host-A 110A may map the network event information, the identity information and the process information to IDFWR2, which is applied to allow the second request. Here, IDFWR2 270 may be configured to only allow second user 192 with (user ID=Y, group=IT) to use an authorized/approved/verified process with process hash=“OPQR” or “ABCD” (see 271-272) to access resource(s) from finance server 203. All other non-authorized or potentially malicious processes used by second user 192 will be blocked from accessing finance server 203 (see 273).

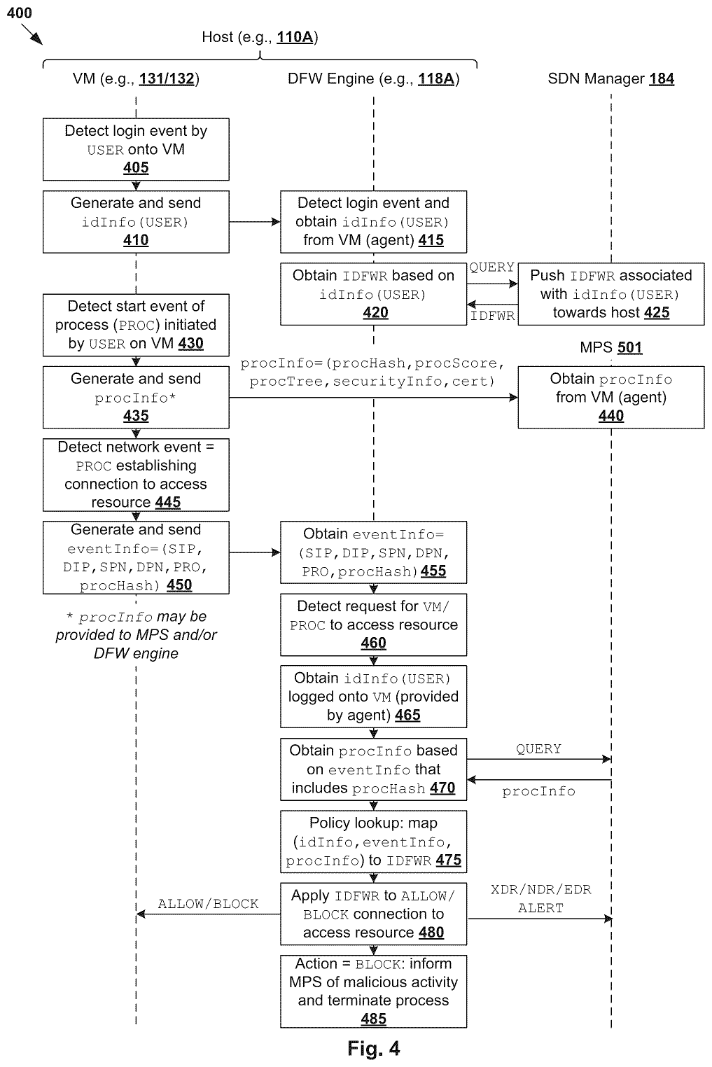

Using examples of the present disclosure, more granular identity firewall rules may be configured and enforced to allow resource access by legitimate (e.g., authenticated) users using authorized processes. Resource access by legitimate users using non-authorized processes will be blocked, such as less secure processes whose vulnerabilities are exploited by fileless malware to launch security attacks. Examples of the present disclosure may be implemented to tie multiple verticals (i.e., users, processes and network connections) together to close or reduce any gap(s) through which malware may spread laterally in SDN environment 100. Various examples will be discussed further below using FIGS. 4-6.

### Detailed Examples

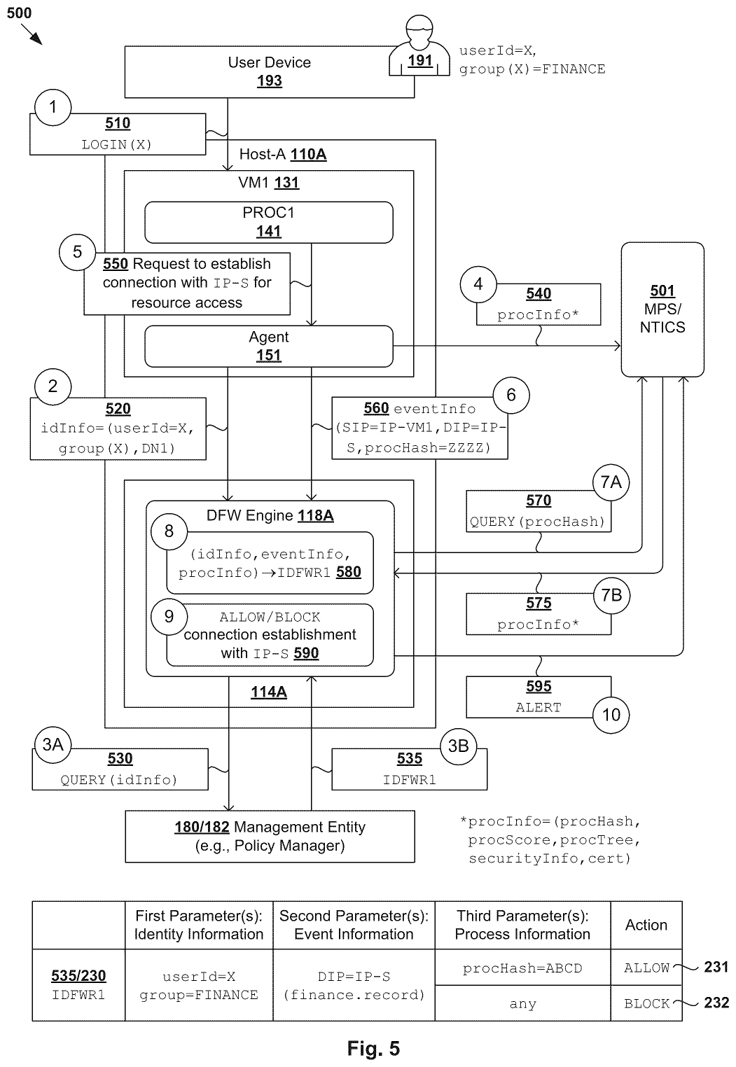

FIG. 4 is a flowchart of example process 400 of process-aware identity firewall in SDN environment 100. Example process 400 may include one or more operations, functions, or actions illustrated at 410 to 485. The various operations, functions or actions may be combined into fewer blocks, divided into additional blocks, and/or eliminated depending on the desired implementation. Example process 400 will be discussed using FIG. 5, which is a schematic diagram illustrating detailed example 500 of process-aware identity firewall according to the example in FIG. 4. In the following, a detailed example will be described with reference to first user 191 operating first user device 193. Similar approach may be implemented for other users, including second user 192 operating second user device 194, etc. The following notations will be used: SIP=source IP address, SPN=source port number (PN), DIP=destination IP address, DPN=destination PN, PRO=protocol, etc.

### (a) Login Event

At 510-520 in FIG. 5, in response to detecting a login event associated with user 191 operating user device 193 to log onto VM1 131, agent 151 may generate and send identity information associated with user 191 and/or user device 193 towards DFW engine 118A. For example, identity information 520 may include (user ID=X, group (X)=FINANCE) associated with user 191. Identity information 520 may also include a username (e.g., John), domain name=DN1, IP-VM1=IP address associated with VM1 131, etc. In response to detecting the login event, DFW engine 118A may store identity information 520. See also blocks 405-415 in FIG. 4.

In practice, the login process may involve authenticating user 191 using any suitable identity management solution, such as Active Directory™ from Microsoft Corporation, VMware Identity Manager™ from VMware, Inc., etc. For example, user 191 may log onto VM1 131 using any suitable Active Directory credentials, such as a user ID, password, etc. In practice, the term “group” may refer generally to a collection of members that may be managed as a single unit, such as staff members assigned to group=FINANCE, etc. Using nesting, a group may be a member of another group.

Guest introspection agent 151 (also known as a “thin agent” or “guest agent”) may be configured to capture events (e.g., login, logout, resource access, etc.) associated with VM1 131. Agent 151 may be configured to interact with hypervisor 114A (e.g., DFW engine 118A) using a communication channel between VM1 131 and hypervisor-A 114A, such as a Virtual Machine Communication Interface (VMCI) channel, etc. Agent 151 may also report the identity information to DFW engine 118A.

### (b) Firewall Rule Retrieval

At 530-535 in FIG. 5, based on identify information 520, DFW engine 118 may obtain a set process-aware identity firewall rule(s) from a management entity, such as by generating and sending a query towards SDN manager 182 capable of acting as a policy manager. For example, IDFWR1 535 (see also 230 in FIG. 2) may be configured to control access to resource(s) on finance server 203 associated with IP address=IP-S. In particular, user 191 associated with (user ID=X, group=FINANCE) is allowed to access finance server 203 using an authorized/approved process with process hash=“ABCD.” Access using other process(es) will be blocked. See also 420-425 in FIG. 4.

Although one firewall rule (i.e., IDFWR1 535) is shown, it should be understood that multiple firewall rules may be retrieved from management entity 182 for accessing different resources on different destination servers. Each process-aware firewall rule may include (a) first parameter(s) mappable to identity information associated with a user/device, (b) second parameter(s) mappable to network event information and (c) third parameter(s) mappable to process information.

### (c) Process Information

At 540 in FIG. 5, in response to detecting a start event initiated by user 191 to start PROC1 141 on VM1 135, agent 151 may generate and send process information associated with PROC1 141 to malware prevention service (MPS) instance 501. Process information 540 associated with PROC1 141 may include a process hash, a process score, process tree information, security information (e.g., cryptographic protocols, certificate information), etc. See 430-440 in FIG. 4.

In practice, process hashes may be used by security software to identify and track different processes, as well as to detect changes to process executable files. A process trust score may be a numeric value that represents the security risk of a computer process. Any suitable approach may be used to calculate a process score. For example, a low score may be assigned to a high-risk process with known vulnerabilities. A process tree may provide a hierarchical representation of multiple processes running on a system. The process tree may be used to identify parent-child relationship among the processes to identify malicious processes. Security information associated with PROC1 141 may include cryptographic protocols, certificate information (if any), etc.

Multiple MPS instances (including MPS instance 501) may be deployed in SDN environment 100 to protect VMs from malware attacks by monitoring processes running on those VMs, such as using a combination of threat intelligence, behavioral analysis, etc. MPS instance 501 may conduct an analysis of a process based on its process information, such by scanning the process in a sandbox, etc. MPS instance 501 may be implemented using any suitable software and/or hardware, such as using a service virtual machine (SVM) supported by host 110A/110B or another system. Additionally or alternatively, agent 151 may provide process information 540 to any other similar service(s), such as NSX® threat intelligence cloud service (NTICS) from VMware, Inc.),

### (d) Network Event Information

At 550-560 in FIG. 5, in response to detecting a network activity/event associated with PROC1 141, agent 151 may generate and send network event information towards DFW engine 118A. For example, network event 550 involves PROC1 141 running on VM1 131 requesting connection establishment with finance server 203 to access finance records. Network event information 560 may include five tuples associated with the connection, such as SIP=IP-VM1 associated with source VM1 131, DIP=IP-S associated with finance server 203, SPN=SPN1, DPN=DPN1, PRO (e.g., TCP/UDP), etc. Network event information 560 may also include process hash=“ZZZZ” associated with PROC1 141 requesting the connection establishment. In response to receiving network event information 560 from agent 151, DFW engine 118A may detect that PROC1 141 running on VM1 131 is requesting for access to resource(s) from DIP=IP-S associated with finance server 203. See 445-455 in FIG. 4.

### (e) Firewall Rule Enforcement

At 570-575 in FIG. 5, in response to detecting PROC1 141 requesting a connection establishment with finance server 203, DFW engine 118A may obtain (a) identity information identifying user 191 who has logged onto VM1 131 using user device 193 and (b) process information associated with PROC1 141. Identity information 520 previously provided by agent 151 may include (user ID=X, group=FINANCE). Process information 575 may be obtained from any suitable source, such as MPS instance 501 (as shown in FIG. 5) or agent 151 running on VM1 131. Process information 575 may include process hash=“ZZZZ,” process score, process tree information, security information (e.g., cryptographic protocols, certificate information), etc. See also 460-470 in FIG. 4.

At 580 in FIG. 5, DFW engine 118A may perform policy lookup to identify matching IDFWR1 535/230. This involves mapping (a) identity information 520 associated with user 191 or device 193 with first parameter(s) of IDFWR1 230, (b) network event information 560 from agent 151 with second parameter(s) of IDFWR1 230 and (c) process information from MPS instance 501 or agent 151 with third parameter(s) of IDFWR1 230. Using examples of the present disclosure, DFW engine 118A may determine whether an approved user is using an approved process to initiate an approved network connection. Only legitimate users, or users belonging to a particular group, are allowed to access critical servers (e.g., finance server 203) using certain processes. See also 475-480 in FIG. 4.

At 590 in FIG. 5, DFW engine 118A may apply IDFWR1 535 to allow or block the connection establishment request because PROC1 141 is not associated with approved process hash=“ABCD” specified by IDFWR1 230 (see also 231-232). When blocked, associated connection establishment packet(s) addressed from VM1 131 to finance server 203 may be dropped. Depending on the desired implementation, PROC1 141 may be terminated or quarantined. This way, potentially malicious network connections may be blocked or stopped by agent 151 at the source (i.e., VM1 131) itself. See also 480-485 in FIG. 4.

Further, at 595 in FIG. 5, DFW engine 118A may be configured to generate and send any suitable alert(s) to inform MPS instance 501 (or any other threat intelligence service) of potential malicious activity. The alert(s) may include any suitable information to facilitate security technologies such as extended detection and response (XDR), network detection and response (NDR), endpoint detection and response (EDR), etc. The alert(s) may be consumed by any suitable security monitoring tool or dashboards for analysis by network administrator(s), such as Splunk® from Splunk Inc., network operations center (NOC) dashboard, security operations center (SOC) dashboard, etc.

### Example Firewall Rules

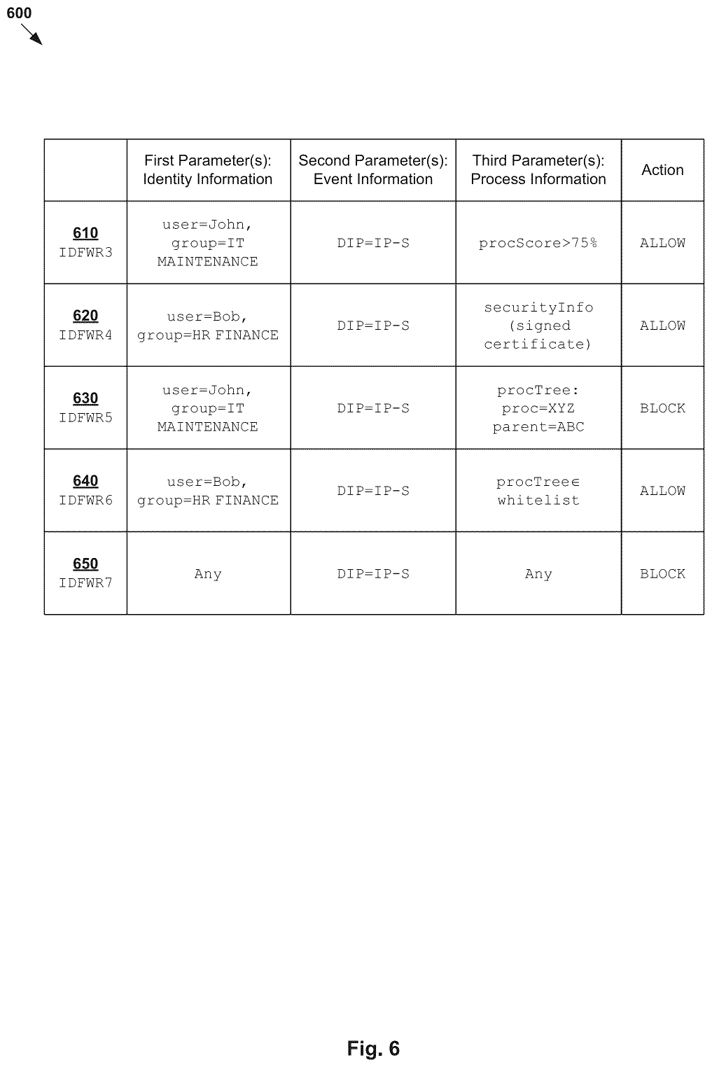

In practice, any suitable process information may be used to configure more fine-tuned firewall rules to implement examples of the present disclosure. Besides process hash information, a combination of process score information, process tree information and process security information may be used. Some examples are shown in FIG. 6, which is a schematic diagram illustrating various examples 600 of process-aware identity firewall rules. These rules are denoted as IDFWR3 to IDFWR6 below.

At 610 in FIG. 6, IDFWR3 may be configured to include parameters that are mappable to identity information (e.g., username=John, group=IT MAINTENANCE), network event information (e.g., DIP=IP-S associated with finance server 203) and process information (e.g., process trust score >75%). This is to authorize member(s) of group=IT MAINTENANCE to access finance server 203 using a process with a relatively high trust score of greater than 75%. In this case, DFW engine 118A/118B may determine whether to allow or block access control by comparing a process score with a threshold specified by IDFWR3 610.

At 620 in FIG. 6, IDFWR4 may be configured to include parameters that are mappable to identity information (e.g., username=Bob, group=HR FINANCE), network event information (e.g., DIP=IP-S associated with finance server 203) and process information (e.g., signed certificate information). This is to authorize member(s) of group=HR FINANCE to access a certain database (e.g., Concur® database from SAP SE) on finance server 203 using a process in the form of a valid signed client. In this case, DFW engine 118A/118B may determine whether to allow or block access control based on whether the security information specifies a signed certificate required by IDFWR4 620.

At 630 in FIG. 6, IDFWR5 may be configured to include parameters that are mappable to identity information (e.g., username=John, group=IT MAINTENANCE), network event information (e.g., DIP=IP-S associated with finance server 203) and process tree information specifying child process=“XYZ” and parent process=“ABC.” This is to block member(s) of group=IT MAINTENANCE from accessing finance server 203 using child process=“XYZ” whose parent process=“ABC.” For example, the child process (e.g., putty.exe) may be a malicious macro created using the parent process (e.g., word processor) that is trying to get access via secure shell (SSH) using putty.

At 640 in FIG. 6, IDFWR6 may be configured to allow network connection(s) based on process tree information. Here, IDFWR6 may include parameters that are mappable to identity information (e.g., username=Bob, group=HR FINANCE), network event information (e.g., DIP=IP-S associated with finance server 203) and process tree information specifying a whitelist of allowed process trees. This is to authorize member(s) of group=HR FINANCE to access finance server 203 using a process from the whitelist. If the parent or grandparent process is suspicious, the child or grandchild process may also be suspicious. At 650, IDFWR7 may be configured to block all other network connections with finance server 203.

### Container Implementation

Although explained using VMs 131-134, it should be understood that public cloud environment 100 may include other virtual workloads, such as containers, etc. As used herein, the term “container” (also known as “container instance”) is used generally to describe an application that is encapsulated with all its dependencies (e.g., binaries, libraries, etc.). In the examples in FIG. 1 to FIG. 6, container technologies may be used to run various containers inside respective VMs 131-134. Containers are “OS-less”, meaning that they do not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. The containers may be executed as isolated processes inside respective VMs.

### Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 6. For example, a computer system capable of acting as host 110A/110B or management entity 182 may be deployed in SDN environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

1. A method for a first computer system to implement a process-aware identity firewall, wherein the method comprises:
based on network event information, detecting a request for a virtualized computing instance supported by the first computer system to access a resource from a second computer system;
obtaining (a) identity information identifying a user or a user device associated with the virtualized computing instance and (b) process information associated with a process that initiates the request to access the resource;
mapping the identity information, the network event information and the process information to an identity firewall rule that includes at least (a) a first parameter that is mappable to the identity information, (b) a second parameter that is mappable to the network event information and (c) a third parameter that is mappable to the process information; and
applying the identity firewall rule to allow or block the request to access the resource, thereby controlling access to the resource based on the identity information, the network event information, and the process information.

2. The method of claim 1, wherein mapping the identity information to the identity firewall rule comprises:
mapping the identity information to the first parameter that specifies at least one of the following: a user identifier (ID) or username associated with the user, a group associated with the user and a domain name associated with the user.

3. The method of claim 1, wherein mapping the process information to the identity firewall rule comprises:
mapping the process information to the third parameter that specifies at least one of the following: a process hash associated with the process, a process score associated with the process, process tree information associated with the process, and security information associated with the process.

4. The method of claim 3, wherein applying the identity firewall rule comprises one of the following:
determining whether to allow or block the request based on the process hash associated with the process;
determining whether to allow or block the request by comparing the process score with a threshold specified by the identity firewall rule;
determining whether to allow or block the request based on the process tree information specifying at least the process and a parent process; and
determining whether to allow or block the request based on whether the security information specifies a signed certificate required by the identity firewall rule.

5. The method of claim 1, wherein detecting the connection establishment comprises:
obtaining the network event information from a guest introspection engine supported by the virtualized computing instance, wherein the network event information includes at least one of the following: source address information or source port number associated with the virtualized computing instance, destination address information or destination port number associated with the second computer system.

6. The method of claim 5, wherein obtaining the process information comprises:
in response to receiving the network event information, obtaining the process information from (a) the malware protection service (MPS) instance that is capable of obtaining the process information from the guest introspection engine or (b) the guest introspection engine itself.

7. The method of claim 1, wherein applying the identity firewall rule comprises:
generating and sending one or more alerts to the MPS instance or a threat intelligence service to facilitate at least one of the following: extended detection and response (XDR), network detection and response (NDR) and endpoint detection and response (EDR).

8. A non-transitory computer-readable storage medium that includes a set of instructions which, in response to execution by a processor of a computer system, cause the processor to perform a method of process-aware identity firewall, wherein the method comprises:
based on network event information, detecting a request for a virtualized computing instance supported by the computer system to access a resource;
obtaining (a) identity information identifying a user or a user device associated with the virtualized computing instance and (b) process information associated with a process that initiates the request to access the resource;
mapping the identity information, the network event information and the process information to an identity firewall rule that includes at least (a) a first parameter that is mappable to the identity information, (b) a second parameter that is mappable to the network event information and (c) a third parameter that is mappable to the process information; and
applying the identity firewall rule to allow or block the request to access the resource, thereby controlling access to the resource based on the identity information, the network event information, and the process information.

9. The non-transitory computer-readable storage medium of claim 8, wherein mapping the identity information to the identity firewall rule comprises:
mapping the identity information to the first parameter that specifies at least one of the following: a user identifier (ID) or username associated with the user, a group associated with the user and a domain name associated with the user.

10. The non-transitory computer-readable storage medium of claim 8, wherein mapping the process information to the identity firewall rule comprises:
mapping the process information to the third parameter that specifies at least one of the following: a process hash associated with the process, a process score associated with the process, process tree information associated with the process, and security information associated with the process.

11. The non-transitory computer-readable storage medium of claim 10, wherein applying the identity firewall rule comprises one of the following:
determining whether to allow or block the request based on the process hash associated with the process;
determining whether to allow or block the request by comparing the process score with a threshold specified by the identity firewall rule;
determining whether to allow or block the request based on the process tree information specifying at least the process and a parent process; and
determining whether to allow or block the request based on whether the security information specifies a signed certificate required by the identity firewall rule.

12. The non-transitory computer-readable storage medium of claim 8, wherein detecting the connection establishment comprises:
obtaining the network event information from a guest introspection engine supported by the virtualized computing instance, wherein the network event information includes at least one of the following: source address information or source port number associated with the virtualized computing instance, destination address information or destination port number associated with the second computer system.

13. The non-transitory computer-readable storage medium of claim 12, wherein obtaining the process information comprises:
in response to receiving the network event information, obtaining the process information from (a) the malware protection service (MPS) instance that is capable of obtaining the process information from the guest introspection engine or (b) the guest introspection engine itself.

14. The non-transitory computer-readable storage medium of claim 8, wherein applying the identity firewall rule comprises:
generating and sending one or more alerts to the MPS instance or a threat intelligence service to facilitate at least one of the following: extended detection and response (XDR), network detection and response (NDR) and endpoint detection and response (EDR).

15. A computer system, comprising a virtualized computing instance, and a firewall engine to:
based on network event information, detect a request for the virtualized computing instance to access a resource;
obtain (a) identity information identifying a user or a user device associated with the virtualized computing instance and (b) process information associated with a process that initiates the request to access the resource;
map the identity information, the network event information and the process information to an identity firewall rule that includes at least (a) a first parameter that is mappable to the identity information, (b) a second parameter that is mappable to the network event information and (c) a third parameter that is mappable to the process information; and
apply the identity firewall rule to allow or block the request to access the resource, thereby controlling access to the resource based on the identity information, the network event information, and the process information.

16. The computer system of claim 15, wherein the firewall engine is to map the identity information to the identity firewall rule by performing the following:
map the identity information to the first parameter that specifies at least one of the following: a user identifier (ID) or username associated with the user, a group associated with the user and a domain name associated with the user.

17. The computer system of claim 15, wherein the firewall engine is to map the process information to the identity firewall rule by performing the following:
map the process information to the third parameter that specifies at least one of the following: a process hash associated with the process, a process score associated with the process, process tree information associated with the process, and security information associated with the process.

18. The computer system of claim 17, wherein the firewall engine is to apply the identity firewall rule by performing one of the following:
determine whether to allow or block the request based on the process hash associated with the process;
determine whether to allow or block the request by comparing the process score with a threshold specified by the identity firewall rule;
determine whether to allow or block the request based on the process tree information specifying at least the process and a parent process; and
determine whether to allow or block the request based on whether the security information specifies a signed certificate required by the identity firewall rule.

19. The computer system of claim 15, wherein the firewall engine is to detect the connection establishment by performing the following:
obtain the network event information from a guest introspection engine supported by the virtualized computing instance, wherein the network event information includes at least one of the following: source address information or source port number associated with the virtualized computing instance, destination address information or destination port number associated with the second computer system.

20. The computer system of claim 19, wherein the firewall engine is to obtain the process information by performing the following:
in response to receiving the network event information, obtain the process information from (a) the malware protection service (MPS) instance that is capable of obtaining the process information from the guest introspection engine or (b) the guest introspection engine itself.

21. The computer system of claim 15, wherein the firewall engine is to apply the identity firewall rule by performing the following:
generate and send one or more alerts to the MPS instance or a threat intelligence service to facilitate at least one of the following: extended detection and response (XDR), network detection and response (NDR) and endpoint detection and response (EDR).
